(19) United States
(12) Patent Application Publication
(10) Pub. No.: US 2005/0137888 A1
(43) Pub. Date: Jun. 23, 2005

(54) Method for commoditizing elements of previously specialized communications link

(75) Inventors: Stephen G. Evangelides JR., Red Bank, NJ (US); Jay P. Morreale, Summit, NJ (US); Michael J. Neubelt, Little Silver, NJ (US); Mark K. Young, Monmouth Junction, NJ (US); Jonathan A. Nagel, Brooklyn, NY (US); David S. DeVincentis, Flanders, NJ (US)

Correspondence Address: MAYER, FORTKORT & WILLIAMS, PC, 251 NORTH AVENUE WEST, 2ND FLOOR, WESTFIELD, NJ, 07090, US

(73) Assignee: Red Sky Systems, Inc.

(21) Appl. No.: 10/739,929

(22) Filed: Dec. 18, 2003

(51) Int. Cl. G06F 17/60

(52) U.S. Cl. 705/1

(57) ABSTRACT

A method for entering a market with high barriers to entry and a plurality of proprietary business elements includes converting at least one of the business elements into a universal business element that can accept a wide variety of inputs from other business elements, while converting a remaining one of the plurality of business elements to commoditized business elements. For example, one exemplary embodiment of the present invention employs an optical repeater that can accept any existing submarine cable, in combination with an optical line interface terminal that can accept existing terrestrial terminal equipment. Regarding market division, this embodiment is specifically limited to spans of less than 5000 kilometers, and preferably between 350 and 4000 kilometers, thereby straddling both the long-haul and short-haul markets while providing highly desirable services and capability. By selecting this market segment, the embodiment achieves highly desirable economics without the usual concomitant high engineering costs.

### FIELD OF THE INVENTION

The present invention is directed generally to methods for converting vertically integrated communications business processes into horizontally integrated communications businesses, and more particularly to a method for converting a vertically integrated communications business into a horizontally integrated communications business that enables new business opportunities for a single entity.

### BACKGROUND

The undersea optical telecommunications market comprises an exemplary vertically integrated business. This market is segmented into short-haul and long-haul operations. Short-haul, or repeater-less systems employ links without powered in-line amplification (hence the term repeater-“less”). Short-haul links typically rely on high optical signal launch power from shore to overcome any inherent loss in the line. Very short point-to-point or lateral/spur network topologies are typically implemented using repeater-less technologies. This solution is attractive because of the lower capital costs that result from the elimination of line amplification as well as the associated power supply and power-carrying elements in the undersea cable.

Repeater-less systems are generally limited to links of about 250 km in length. A maximum upper limit of 400-450 km is observed in practice because the line loss, which scales with distance, outstrips available line gain, the ability to launch more power into the line, and the ability of the system to resolve the received optical signal. As a result, repeater-less networks often are forced to incorporate less desirable network landing points, from political or economic standpoints, because of the inherent distance limitation imposed by the underlying non-amplified technology.

By comparison, the long-haul undersea market segment is addressed by highly-engineered technical solutions that are custom designed for each application. In this market segment, very sophisticated transmission techniques are employed to maximize bandwidth capacity and system reach. While the technology used is highly capable, it is also complex and time-consuming to design, test and deploy. Initial capital costs in long-haul systems tend to be very high, although per-bit transport costs are often attractive if the systems are built-out to maximum design capacity through Dense Wavelength Division Multiplexing (DWDM) technology where many data streams at varying wavelengths are simultaneously carried on the same line.

Long-haul technology generally is not economically scalable downwards to systems having shorter length and capacity requirements. As bandwidth demand is less on shorter regional routes compared with the big transoceanic “pipes,” high design capacity is not available to drive the favorable economics associated with the long-haul technology. And, as long-haul technology is expressly designed to meet the long-distance and large bandwidth capacity demanded in the sector, it is simply not possible from feature set and engineering viewpoints to decontent a long-haul platform to meet the more modest requirements of the regional market.

For any new business trying to enter either of these markets, there are significant barriers to entry, including but not limited to high capital investment, long time to market, and large equipment purchases for inventory, which can be obsolete technology in a short period of time.

The present invention is therefore directed to the problem of developing a method and apparatus for enabling a business to enter these markets rapidly and without necessarily satisfying existing barriers to entry.

### SUMMARY OF THE INVENTION

The present invention solves these and other problems by providing a combination of technology and market division that enables conversion of otherwise proprietary systems to commodity equipment that can work with a wide variety of existing vendor equipment while competing technologically with highly engineered solutions.

For example, one exemplary embodiment of the present invention employs a optical repeater that can be used with a wide variety of different existing submarine cables, in combination with an optical line interface terminal that can accept existing terrestrial terminal devices. Regarding market division, this embodiment is specifically limited to spans of less than about 4000 kilometers, thereby straddling both the long-haul and short-haul markets while providing highly desirable services and capability. By selecting this market segment, the embodiment achieves highly desirable economics without the usual concomitant high engineering costs.

In accordance with one aspect of the invention, a method is provided for reducing barriers to entry in a submarine optical communications business. The method begins by providing a submarine optical transmission line and at least one repeater located along the optical transmission line. The repeater has a plurality of interfaces to accept multiple cable types. An optical interface is provided to accept a plurality of types of commodity-based terrestrial terminal equipment. The optical interface provides optical-level connectivity between the transmission line and any of the commodity-based terrestrial terminal equipment.

In accordance with another aspect of the invention, the method further includes the step of limiting a length of the optical transmission line to less than about 5000 kilometers.

In accordance with another aspect of the invention, the method further includes the step of limiting a length of the optical transmission line to between about 350 km and 4000 km.

In accordance with another aspect of the invention, a length of the optical transmission line is limited to lengths corresponding to those between conventional short-haul unrepeatered and long-haul repeatered undersea telecommunications systems.

In accordance with another aspect of the invention, the method further includes the step of providing a comprehensive set of system design and integration services that wraps around a hardware suite that includes the optical transmission line, the repeater, and the optical interface.

In accordance with another aspect of the invention, the repeater includes an optical amplifier that integrates with an existing pressure housing supplied by a third party vendor to create a relatively low cost optical repeater for use along the optical transmission line

In accordance with another aspect of the invention, a method is provided for creating a business that operates between conventional short-haul unrepeatered and long-haul repeatered undersea telecommunications markets. The method begins by providing an optical transmission line having a length less than about 5000 kilometers and an optical amplifier that integrates with an existing pressure housing supplied by a third party vendor to create a relatively low cost optical repeater for use along the optical transmission line. An interface is also provided that allows transmission terminal equipment from a plurality of third party transmission terminal equipment vendors to communicate over the optical transmission line.

In accordance with another aspect of the invention, the optical amplifier further integrates with a cable supplied by a third party vendor.

In accordance with another aspect of the invention, the method further includes the step of providing a comprehensive set of system design and integration services that wraps around a hardware suite that includes the optical transmission line, the optical amplifier, and the interface.

In accordance with another aspect of the invention, the transmission terminal equipment is terrestrial terminal equipment available from a plurality of third party terrestrial transmission equipment vendors.

In accordance with another aspect of the invention, a method is provided for penetrating an undersea optical communications market with high barriers to entry. The method begins by converting one or more proprietary elements of a communications system serving the market to one or more commoditized elements. In addition, an interface is provided to the communications system such that pre-existing terminal equipment can operationally interface with the communication system. Finally, operations of the communications system are limited to a market niche between two industry-recognized segments of the undersea optical communications market.

In accordance with another aspect of the invention, the one or more proprietary elements comprises a repeater housing.

In accordance with another aspect of the invention, the one or more commoditized elements is an undersea pressure vessel designed to house a cable joint.

In accordance with another aspect of the invention, the one or more commoditized elements is an undersea pressure vessel designed to house a cable joint.

In accordance with another aspect of the invention, a business method is provided. The method begins by providing a submarine cable-independent optical repeater that is operational with a plurality of undersea cables available from different manufacturers and an optical interface to a plurality of different terminal equipment available from different manufacturers. The submarine cable-independent optical repeater and the optical interface are incorporated into a submarine optical transmission system.

In accordance with another aspect of the invention, system spans are limited to about 5000 kilometers.

In accordance with another aspect of the invention, system spans are limited to between about 350 and 4000 kilometers.

In accordance with another aspect of the invention, system spans are limited to lengths corresponding to a market niche between two industry-recognized segments of the undersea optical communications market.

In accordance with another aspect of the invention, a market segmentation method is provided for use in undersea telecommunications. The method employs an optical transmission line that operates between conventional short-haul unrepeatered and long-haul repeatered undersea telecommunications markets. The method also employs an interface that allows transmission equipment from a plurality of third party transmission equipment vendors to communicate over the optical transmission line.

In accordance with another aspect of the invention, the transmission equipment is undersea terminal equipment available from a third party undersea transmission equipment vendor.

### BRIEF DESCRIPTION OF THE DRAWINGS

FIG. 1 depicts an exemplary embodiment of an undersea telecommunications system according to one aspect of the present invention.

FIG. 2 depicts a flow chart of a method for reducing barriers to entry in a communications business that operates using highly proprietary technology and single designed systems according to another aspect of the present invention.

FIG. 3 depicts a flow chart of a method for creating a business that operates between short haul and long haul undersea telecommunications markets according to still another aspect of the present invention.

FIG. 4 depicts a flow chart of a method for penetrating a market with high barriers to entry according to yet another aspect of the present invention.

FIG. 5 depicts a flow chart of a business method according to a further aspect of the present invention.

FIG. 6 depicts a flow chart of a method for entering a market with high barriers to entry and a plurality of proprietary business elements according to yet another aspect of the present invention.

FIG. 7 depicts a flow chart of a method for converting a vertical business to a horizontal business according to still another aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

According to one aspect of the present invention, existing Wavelength Division Multiplexed (“WDM”) terrestrial and undersea technologies are merged into a feature-rich, yet low-cost platform that is purpose-built for the regional undersea market—a market that is significant, robust, and totally underserved by incumbent undersea suppliers.

Embodiments of the present invention are designed for undersea networks having maximum link distances of about 5,000 kilometers. Within this sector, the business model tracks extremely well to significant opportunities in the range of 350 to 4,000 kilometers. This range defines a market gap where current short-haul platforms hit a technological limit and long-haul solutions cannot be economically scaled downward.

In addition, an embodiment of an undersea network utilizes a small form factor optical amplifier that integrates with existing pressure housings and cable supplied by other companies to create a very low cost optical line amplifier, which is called a “repeater.”

Optical line interface (OLI) equipment allows transmission terminal equipment from most major terrestrial vendors to drive a market-specific amplified line having carefully managed transmission characteristics, including for example chromatic dispersion compensation. A comprehensive set of system design and integration services wraps around the entire hardware suite to complete this market penetration strategy

By creating a terminal-independent and submarine cable-independent system platform, capital requirements for market entry are minimized while very attractive margins are realized. In addition, a multi-supplier platform provides the greatest leverage against each supplier's fundamental capabilities to ensure that regional network customers gain the most optimized and cost effective solution for the entire deployed network—from land-based terminal and interface equipment, to undersea amplified line, to network installation and maintenance.

Creating an end-to-end solution using commodity equipment from the more competitive terrestrial space drives additional customer benefits. These include: flexibility in network provisioning; network operational transparency; savings in operator training; and sparing costs. These advantages substantially drive down both customers' initial capital costs and operational expense, particularly when compared with less cost-optimized “vertically integrated” and heavily-customized solutions.

The regional undersea market is approximately positioned between short-haul “repeater-less” (also known as the “festoon” market) and the long-haul transoceanic repeatered markets. Typical regional network links (from landing point to landing point) run between 350 to 2,000 km in length and are used to implement intra-regional telecommunication networks and inter-connectivity solutions between regional and high-capacity transoceanic undersea networks. The regional market is characterized by moderate bandwidth capacity requirements compared with the long-haul market. Regional networks require significantly shorter link distances with a practical upper limit of around 5,000 km.

More than a mere “niche,” the regional undersea market represents a very significant opportunity in and by itself as carriers and network operators look to solve “connectivity” rather than capacity concerns.

By providing critically enabling technologies, a collection of outsourced commoditized products can be seamlessly integrated to create a new target market-responsive solution. This technology is divided into undersea and land-based equipment.

The technology developed for the undersea portion according to one aspect of the present invention is purposefully simple, modular, and robust to radically simplify system design, manufacturing and deployment. Development costs, product costs, and time to market are substantially reduced through this approach. The capabilities and feature set of the technology is further carefully selected to balance cost and performance in exact alignment with the requirements of the target market. For example, ultimate bandwidth capacity and fiber counts are both modest by long-haul standards. However, regional undersea customers typically have lower capacity requirements since they do not aggregate as much traffic as trans-oceanic service providers.

The land-based technology of the present invention is designed to perfectly complement the capability of the undersea technology. More specifically as the feature set of the undersea technology is purposefully streamlined to lower costs and increase reliability, the land-based technology requirements decrease as a result, thus opening up a broader range of terminal solutions to the customer. This provides the opportunity to offer a multi-vendor terminal solution through the use of the OLI of the present invention.

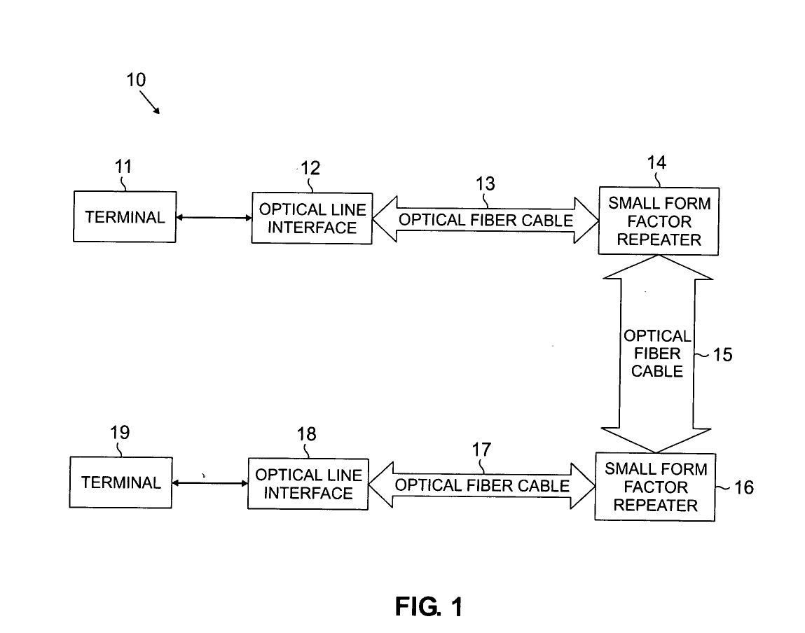

FIG. 1 depicts an exemplary embodiment 10 of a system operating in accordance with one aspect of the present invention. The system includes terminal equipment 11, 19, fiber optic cable segments 13, 15, 17, optical line interfaces 12, 18, and small form factor repeaters 14, 16. While only two repeaters are shown and only three cable segments are shown, other numbers could be used without departing from the scope of the present invention.

Small Form Factor Optical Line Amplifier

U.S. patent application Ser. No. 10/687,547 discloses one embodiment of a small form factor optical line amplifier that may be employed in the present invention, which U.S. patent application Ser. No. 10/687,547 is hereby incorporated by reference as if repeated herein in its entirety, including the drawings. The optical line amplifier 14, 16 comprises a small form factor device that integrates into existing submarine qualified pressure and tension housings produced by established suppliers in the submarine space. In one embodiment of the invention the existing submarine qualified pressure and tension housing is conventionally employed to house a submarine cable joint.

The repeater of the present invention employs a conventional erbium-doped fiber amplifier (EDFA) design, in which the amplifier bandwidth is carefully matched to the capacity requirements of the target market. Low parts count, the use of existing submarine-qualified components, and the judicious use of active controllers simplifies the amplifier design to increase reliability and manufacturability and sharply reduce cost. When deployed in a line designed according to one aspect of the present invention, the amplifier avoids the necessity for bulk gain shape adjustments or dispersion compensation on a per amplifier basis. This results in an amplifier that radically simplifies system integration prior to deployment and increases system maintenance flexibility with a substantial reduction in both as-deployed and as-maintained system cost.

In some embodiments of the present invention, the amplifiers are preferably configured to consume very low power to increase the inherent reliability of the pump lasers, reduce thermal loads, and lessen the power producing and carrying requirements on the DC power supply and undersea cable, respectively. Such a design not only increases overall amplifier reliability, but also substantially lowers costs in the cable because both the power conductor (typically formed from copper) and the dielectric sheathing (typically a medium or high-density polyethylene) can be made smaller in size. When configured as a full up repeater, the ultra-small-form-factor repeater of the present invention generates very small amounts of waste heat and thus can be stored in shipboard cable “tanks” or on deck without external cooling. Such features enhance installation ease while lowering overall costs.

Optical Line Interface

U.S. patent application Ser. No. 10/621,028 discloses one embodiment of an Optical Line Interface device that may be employed in an undersea telecommunications system in accordance with the present invention, which U.S. patent application Ser. No. 10/621,028 is hereby incorporated by reference as if repeated herein in its entirety, including the drawings. The land-based optical line interface (“OLI”) 12, 18 enables a variety of unmodified terrestrial grade terminal products from multiple vendors to drive the undersea-amplified line. The OLI fits between the terminal equipment and the amplified line to provide optical signal conditioning and grooming at both the launch and receive end of the system. In addition, the OLI provides the required line monitoring, power feed, and optical service channel functionalities that are unique to the undersea telecommunications environment.

In its interface role, the OLI ensures that the terminal equipment—independent of terminal vendor, modulation format, launch power and other characteristics—successfully transmits and receives data over the undersea, amplified line. The OLI conditions the optical signal at both transmitter and receiver to compensate for line impairments, such as chromatic dispersion and cross-phase modulation, as well as to improve signal-to-noise ratio in the end-to-end system. Raman amplification may be provided in the OLI to increase system reliability and lower costs by increasing the distance from shore to the first repeater, thereby reducing incidents of external aggression close to shore while simultaneously eliminating or the reducing the need for repeater burial.

Terminal

Similar to the fiber optic cable, the terminal equipment 11, 19 employed in this system 10 can be conventional land-line terminal equipment. This is another aspect of the present invention, in that most any type of pre-existing terminal equipment can be employed, enabling the system designer to purchase the most cost effective terminal equipment at the time. Moreover, this enables the system operator and builder to avoid maintaining supplies of terminal equipment, thereby reducing the inventory costs associated with this business. As such, this element of the system can be a commodity item. Examples of terminal equipment that are currently available and which may be used in connection with the present invention include, but are not limited to, the Nortel LH1600 and LH4000, Siemens MTS 2, Cisco 15808 and the Ciena CoreStream long-haul transport products. The terminal equipment may also be a network router in which Internet routing is accomplished as well the requisite optical functionality. Moreover, the terminal equipment that is employed may conform to a variety of different protocol standards, such SONET/SDH ATM and Gigabit Ethernet, for example.

In some embodiments of the invention the terminal equipment need not be conventional land-line terminal equipment. Rather, the terminal equipment may be pre-existing undersea terminal equipment available from third party vendors. Such equipment may be available from inventory and hence may prove to be the most cost effective terminal equipment at the time. Significantly, this pre-existing terminal equipment is customized for the third party vendor's own undersea transmission system and not for the regional undersea market addressed by the present invention.

### EXEMPLARY EMBODIMENTS

The present inventions set forth herein make possible a wide variety of business methods and processes. Several of these are set forth below. Others should be apparent to those of skill in this art.

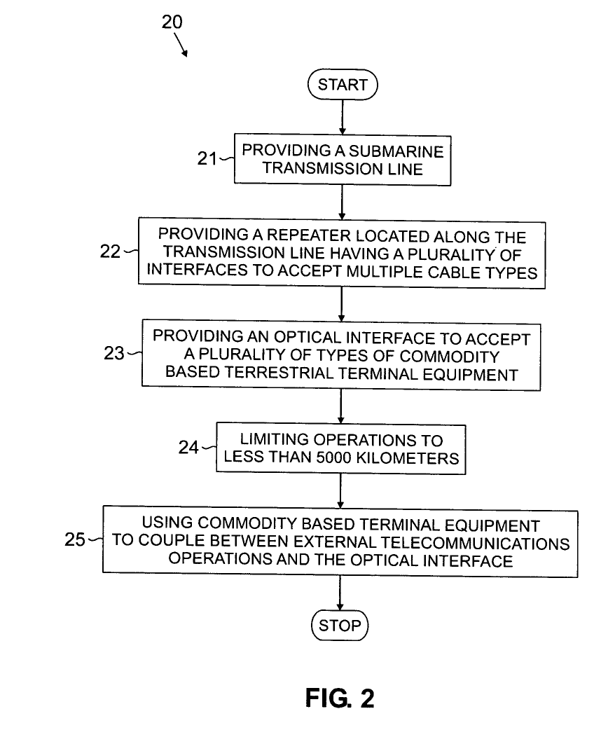

FIG. 2 depicts a flow chart of a method for reducing barriers to entry in a communications business that operates using highly proprietary technology and single designed systems according to another aspect of the present invention. One such system includes the undersea or submarine telecommunications market. According to this method, a submarine transmission line is provided (element 21) as well as a repeater, which repeater is located along the transmission line and has a plurality of interfaces to accept multiple cable types (element 22). In combination with this repeater and transmission line, an optical interface is employed to accept a plurality of commodity-based terrestrial terminal equipment (element 23). Additionally, operations may be limited to within about 5000 kilometers or so (element 24). Moreover, commodity based terminal equipment can be used to couple between external telecommunications operations and the optical interface (element 25). Consequently, a new entity seeking to enter the undersea telecommunications market need not purchase a large amount of inventory for the other elements of an undersea telecommunications system, but rather can purchase these elements on the open market based on other considerations, such as cost, delivery, volume discounts, etc.

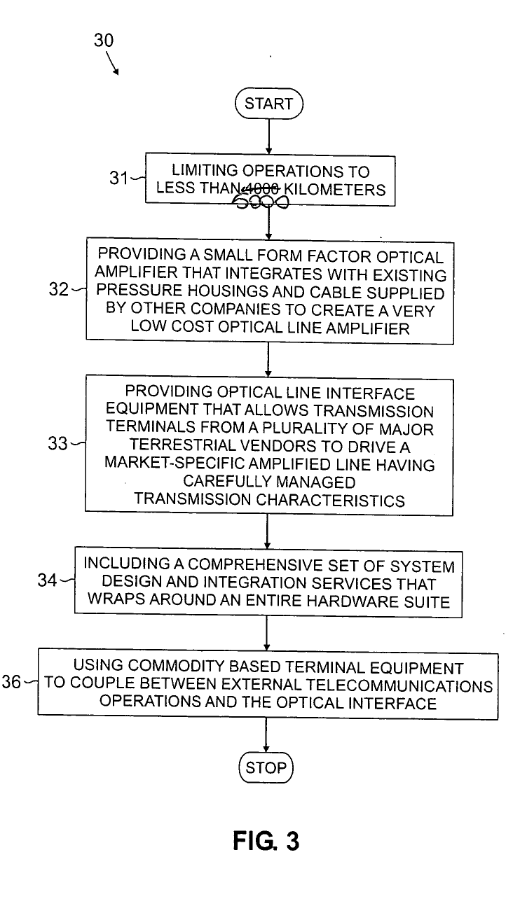

FIG. 3 depicts a flow chart of a method for creating a business that operates between short haul and long haul undersea telecommunications markets according to another aspect of the present invention. In this method, operations are limited to less than 5000 kilometers (element 31). A small form factor optical amplifier is provided, which integrates with existing pressure housings and cable supplied by other companies to create a very low cost optical line amplifier (element 32). Optical line interface equipment is provided, which allows transmission terminals from a plurality of major terrestrial vendors to drive a market-specific amplified line having carefully managed transmission characteristics (element 33). A comprehensive set of system design and integration services wraps around the entire hardware suite to complete this market penetration strategy (element 34). Moreover, commodity based terminal equipment can be used to couple between external telecommunications operations and the optical line interface (element 36). The end result is a system that straddles both the short-haul and long-haul markets, provides some of the benefits of both while not necessarily including the disadvantages of either.

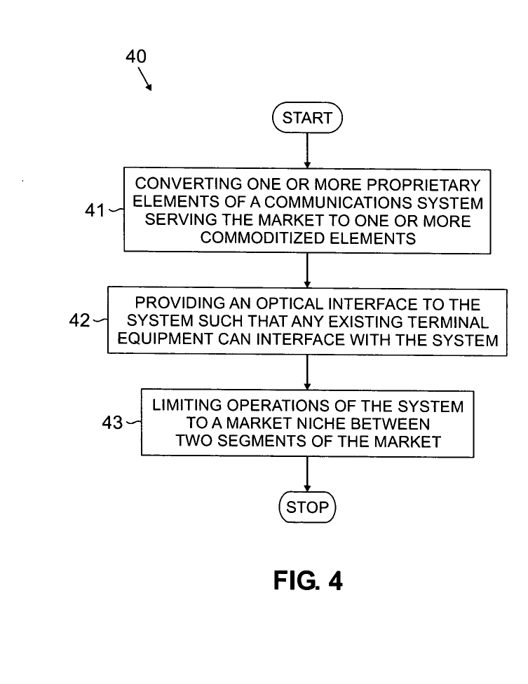

FIG. 4 depicts a flow chart of a general method for penetrating an undersea communications market with high barriers to entry according to yet another aspect of the present invention. According to this method, one or more proprietary elements of a communications system serving the market are converted to one or more commoditized elements (element 41). This is made possible because an optical interface to the system is provided, such that any existing terminal equipment can interface with the system (element 42). This enables the market entrant to use any available equipment rather than proprietary equipment used by existing companies. Operations of the system are then limited to a market niche between two segments of the market (element 43). This enables the market entrant to serve underserved segments of the market. By setting this portion of the market as the target of the business, revenues can be obtained with less competition from existing market participants. This technique or process can be applied to other businesses and not just the undersea telecommunications market.

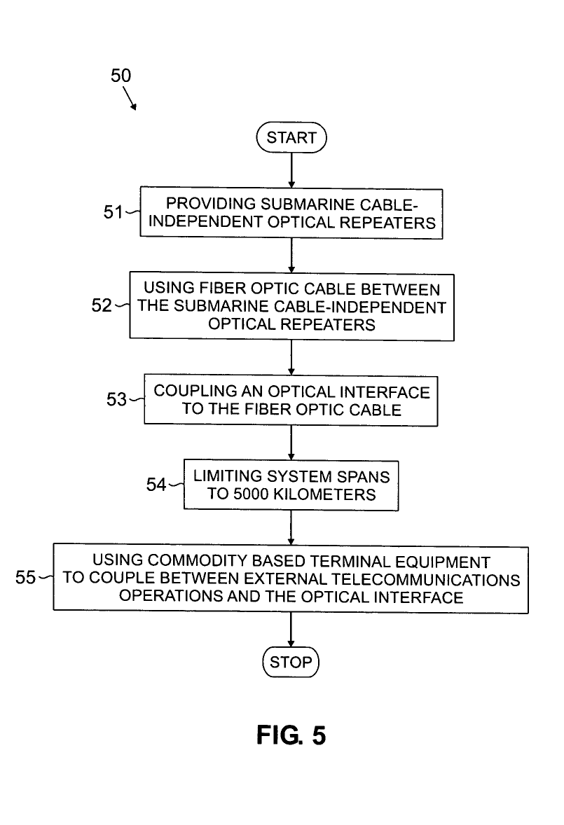

FIG. 5 depicts a flow chart of a business method according to yet another aspect of the present invention. According to this method, submarine cable-independent optical repeaters are provided (element 51). Fiber optic cable is used between the repeaters (element 52). An optical interface is coupled to the fiber optical cable (element 53). System spans are then limited to 5000 kilometers or so (element 54). Moreover, commodity based terminal equipment can be used to couple between external telecommunications operations and the optical interface (element 55). The combination of these elements results in a new business heretofore not possible.

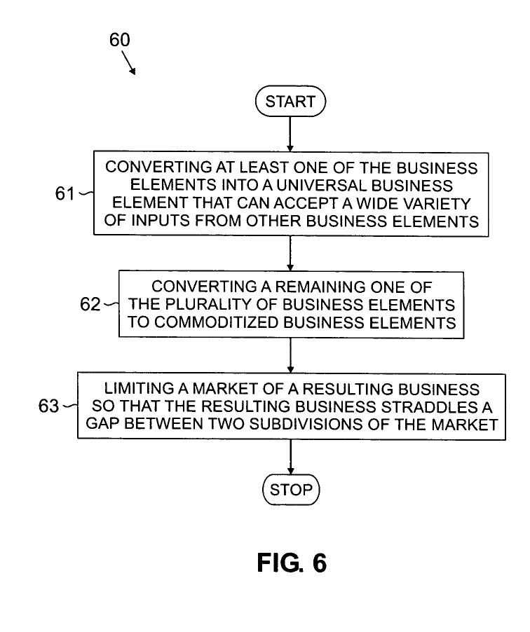

FIG. 6 depicts a flow chart of a general method for entering a market with high barriers to entry and several proprietary business elements according to still another aspect of the present invention. According to this method, at least one of the business elements is converted into a universal business element that can accept a wide variety of inputs from other business elements (element 61). The remaining business elements are converted to commoditized business elements (element 62). A market of a resulting business is limited so that the resulting business straddles a gap between two subdivisions of the market (element 63). This combination of processes enables a market entrant to operate in underserved segments of the market. By setting this portion of the market as the target of the business, revenues can be obtained with less competition from existing market participants. This technique or process can be applied to other businesses—not just the undersea telecommunications market.

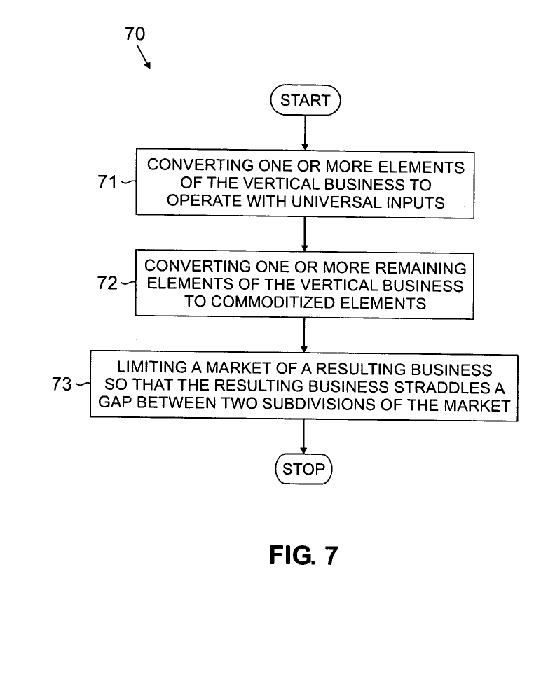

FIG. 7 depicts a flow chart of a general method for converting a vertical business to a horizontal business according to still another aspect of the present invention. According to this method, one or more elements of the vertical business are converted to operate with universal inputs (element 71). One or more of the remaining elements of the vertical business are converted to commoditized elements (element 72). In addition, a market of a resulting business can be limited so that the resulting business straddles a gap between two subdivisions of the market (element 73). As with the above method, this technique can be applied to other businesses—not just the undersea telecommunications market.

Although various embodiments are specifically illustrated and described herein, it will be appreciated that modifications and variations of the invention are covered by the above teachings and are within the purview of the appended claims without departing from the spirit and intended scope of the invention. For example, at least several of the business methods set forth herein are applicable to other markets than the undersea telecommunications market used in the above description. Furthermore, this example should not be interpreted to limit the modifications and variations of the invention covered by the claims but is merely illustrative of possible variations.

1. A method for reducing barriers to entry in a submarine optical communications business, comprising:
providing a submarine optical transmission line;
providing at least one repeater located along the optical transmission line, said repeater having a plurality of interfaces to accept multiple cable types; and
providing an optical interface to accept a plurality of types of commodity-based terrestrial terminal equipment, said optical interface providing optical-level connectivity between the transmission line and any of said commodity-based terrestrial terminal equipment.

2. The method according to claim 1, further comprising the step of limiting a length of the optical transmission line to less than about 5000 kilometers.

3. The method according to claim 1, further comprising the step of limiting a length of the optical transmission line to between about 350 km and 4000 km.

4. The method according to claim 1, further comprising the step of limiting a length of the optical transmission line to lengths corresponding to those between conventional short-haul unrepeatered and long-haul repeatered undersea telecommunications systems.

5. The method of claim 1 further comprising the step of providing a comprehensive set of system design and integration services that wraps around a hardware suite that includes the optical transmission line, the repeater, and the optical interface.

6. The method of claim 1 wherein said repeater includes an optical amplifier that integrates with an existing pressure housing supplied by a third party vendor to create a relatively low cost optical repeater for use along the optical transmission line

7. A method for creating a business that operates between conventional short-haul unrepeatered and long-haul repeatered undersea telecommunications markets, comprising:
providing an optical transmission line having a length less than about 5000 kilometers;
providing an optical amplifier that integrates with an existing pressure housing supplied by a third party vendor to create an optical repeater for use along the optical transmission line; and
providing an interface that allows transmission terminal equipment from a plurality of third party transmission terminal equipment vendors to communicate over the optical transmission line.

8. The method of claim 7 wherein said repeater further integrates with a cable supplied by a third party vendor.

9. The method of claim 7 further comprising the step of providing a comprehensive set of system design and integration services that wraps around a hardware suite that includes the optical transmission line, the repeater, and the interface.

10. The method according to claim 7 wherein said transmission terminal equipment is terrestrial terminal equipment available from a plurality of third party terrestrial transmission equipment vendors.

11. A method for penetrating an undersea optical communications market with high barriers to entry comprising:
converting one or more proprietary elements of a communications system serving said market to one or more commoditized elements;
providing an interface to the communications system such that pre-existing terminal equipment can operationally interface with the communication system; and
limiting operations of the communications system to a market niche between two industry-recognized segments of the undersea optical communications market.

12. The method of claim 11 wherein said one or more proprietary elements comprises a repeater housing.

13. The method of claim 11 wherein said one or more commoditized elements is an undersea pressure vessel designed to house a cable joint.

14. The method of claim 12 wherein said one or more commoditized elements is an undersea pressure vessel designed to house a cable joint.

15. A business method comprising:
providing a submarine cable-independent optical repeater that is operational with a plurality of undersea cables available from different manufacturers;
providing an optical interface to a plurality of different terminal equipment available from different manufacturers; and
incorporating said submarine cable-independent optical repeater and said optical interface into a submarine optical transmission system.

16. The business method according to claim 15, further comprising limiting system spans to 5000 kilometers.

17. The business method according to claim 15, further comprising limiting system spans to between about 350 and 4000 kilometers.

18. The business method according to claim 15, further comprising limiting system spans to lengths corresponding to a market niche between two industry-recognized segments of the undersea optical communications market.

19. The business method according to claim 15 wherein said terminal equipment is terrestrial terminal equipment available from a plurality of third party terrestrial transmission equipment vendors.

20. A market segmentation method for use in undersea telecommunications comprising:
employing an optical transmission line that operates between conventional short-haul unrepeatered and long-haul repeatered undersea telecommunications markets; and
employing an interface that allows transmission equipment from a plurality of third party transmission equipment vendors to communicate over the optical transmission line.

21. The method according to claim 20 wherein said transmission equipment is terrestrial terminal equipment available from a plurality of third party terrestrial transmission equipment vendors.

22. The method according to claim 20 wherein said transmission equipment is undersea terminal equipment available from a third party undersea transmission equipment vendor.

23. The method of claim 20 further comprising employing an optical amplifier that integrates with existing pressure housings and cable supplied by a third party vendor to create a relatively low cost optical repeater for use along the optical transmission line.

24. The method according to claim 20, further comprising limiting a market to distances less than 5000 kilometers.

25. The method according to claim 20, further limiting a market to distances between about 350 km and 4000 km.

26. The method of claim 23 wherein said existing pressure housing is designed to house a cable joint.
